(19) United States
(12) Patent Application Publication
(10) Pub. No.: US 2025/0056481 A1
(43) Pub. Date: Feb. 13, 2025

(54) SYNCHRONIZATION REFERENCE ALIGNMENT

(71) Applicant: Nokia Technologies Oy, Espoo (FI)

(72) Inventors: Prajwal KESHAVAMURTHY, Munich (DE); Hyun-Su CHA, Naperville, IL (US); Taylan SAHIN, Munich (DE)

(21) Appl. No.: 18/796,034

(22) Filed: Aug. 6, 2024

Related U.S. Application Data
(60) Provisional application No. 63/518,472, filed on Aug. 9, 2023.

(51) Int. Cl. H04W 64/00

(52) U.S. Cl. CPC H04W 64/00

(57) ABSTRACT

Example embodiments of the present disclosure relate to devices, methods, apparatuses and computer readable storage medium for synchronization reference alignment. In a method, a server device obtains first information indicating at least one of: a role of a device of at least one device during positioning of a target device based on at least sidelink positioning reference signals, or quality of a plurality of links between the device of the at least one device and a plurality of positioning anchor devices for the positioning of the target device. Based on at least the first information, the server device determines a common synchronization reference source for synchronization of at least one of the plurality of positioning anchor devices.

Various example embodiments of the present disclosure generally relate to the field of telecommunication and in particular, to devices, methods, apparatuses and computer readable storage medium for synchronization reference alignment for sidelink positioning.

### BACKGROUND

Sidelink (SL) positioning are studied in the 3rd Generation Partnership Project (3GPP) Release-18 to expand and improve New Radio (NR) positioning. A target is to support use cases such as vehicle-to-everything (V2X), public safety, commercial and industrial-internet-of-things (IIoT). SL positioning is based on transmissions of SL positioning reference signals (PRSs) by a plurality of anchor user equipment (UEs). In SL positioning, positioning accuracy may depend on synchronization between the anchor UEs. If there is synchronization misalignment among the anchor UEs in a SL positioning session, the positioning accuracy of the target UE may be degraded.

### SUMMARY

In a first aspect of the present disclosure, there is provided a server device. The server device comprises at least one processor; and at least one memory storing instructions that, when executed by the at least one processor, cause the server device at least to: obtain first information indicating at least one of: a role of a device of at least one device during positioning of a target device based on at least sidelink positioning reference signals, or quality of a plurality of links between the device of the at least one device and a plurality of positioning anchor devices for the positioning of the target device; and determine, based on at least the first information, a common synchronization reference source for synchronization of at least one of the plurality of positioning anchor devices.

In a second aspect of the present disclosure, there is provided a device. The device comprises at least one processor; and at least one memory storing instructions that, when executed by the at least one processor, cause the device at least to: transmit first information to a server device, first information indicating at least one of: a role of the device during positioning of a target device based on at least sidelink positioning reference signals, or quality of a plurality of links between the device and a plurality of positioning anchor devices for the positioning of the target device.

In a third aspect of the present disclosure, there is provided a positioning anchor device. The positioning anchor device comprises at least one processor; and at least one memory storing instructions that, when executed by the at least one processor, cause the positioning anchor device at least to: receive, from a server device or from a device being a common synchronization reference source, second information related to the common synchronization reference source, the common synchronization reference source being determined based on at least first information indicating at least one of: a role of the common synchronization reference source during positioning of a target device, or quality of a plurality of links between the common synchronization reference source and a plurality of positioning anchor devices for the positioning of the target device; and determine a synchronization reference source for transmission and reception of a sidelink positioning reference signal based on at least the second information.

In a fourth aspect of the present disclosure, there is provided a method at a server device. The method comprises: obtaining first information indicating at least one of: a role of a device of at least one device during positioning of a target device based on at least sidelink positioning reference signals, or quality of a plurality of links between the device of the at least one device and a plurality of positioning anchor devices for the positioning of the target device; and determining, based on at least the first information, a common synchronization reference source for synchronization of at least one of the plurality of positioning anchor devices.

In a fifth aspect of the present disclosure, there is provided a method at a device. The method comprises: transmitting first information to a server device, first information indicating at least one of: a role of the device during positioning of a target device based on at least sidelink positioning reference signals, or quality of a plurality of links between the device and a plurality of positioning anchor devices for the positioning of the target device.

In a sixth aspect of the present disclosure, there is provided a method at a positioning anchor device. The method comprises: receiving, from a server device or from a device being a common synchronization reference source, second information related to the common synchronization reference source, the common synchronization reference source being determined based on at least first information indicating at least one of: a role of the common synchronization reference source during positioning of a target device, or quality of a plurality of links between the common synchronization reference source and a plurality of positioning anchor devices for the positioning of the target device; and determining a synchronization reference source for transmission and reception of a sidelink positioning reference signal based on at least the second information.

In a seventh aspect of the present disclosure, there is provided a first apparatus. The first apparatus comprises means for obtaining first information indicating at least one of: a role of a device of at least one device during positioning of a target device based on at least sidelink positioning reference signals, or quality of a plurality of links between the device of the at least one device and a plurality of positioning anchor devices for the positioning of the target device; and means for determining, based on at least the first information, a common synchronization reference source for synchronization of at least one of the plurality of positioning anchor devices.

In an eighth aspect of the present disclosure, there is provided a second apparatus. The second apparatus comprises means for transmitting first information to a server device, first information indicating at least one of: a role of the device during positioning of a target device based on at least sidelink positioning reference signals, or quality of a plurality of links between the device and a plurality of positioning anchor devices for the positioning of the target device.

In a ninth aspect of the present disclosure, there is provided a third apparatus. The third apparatus comprises means for receiving, from a server device or from a device being a common synchronization reference source, second information related to the common synchronization reference source, the common synchronization reference source being determined based on at least first information indicating at least one of: a role of the common synchronization reference source during positioning of a target device, or quality of a plurality of links between the common synchronization reference source and a plurality of positioning anchor devices for the positioning of the target device; and means for determining a synchronization reference source for transmission and reception of a sidelink positioning reference signal based on at least the second information.

In a tenth aspect of the present disclosure, there is provided a computer readable medium. The computer readable medium comprises instructions stored thereon for causing an apparatus to perform at least the method according to the fourth, fifth or sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example process of synchronization reference alignment based on first information according to some example embodiments of the present disclosure;

FIG. 3 illustrates an example process of synchronization reference alignment based on the third information related to candidate synchronization reference sources according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a flowchart of a method implemented at a third device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “sidelink positioning reference signal” or “SL PRS” refers to a reference signal transmitted over SL for positioning purposes.

As used herein, the term “SL PRS (pre-)configuration” refers to (pre-)configured parameters of SL PRS such as time-frequency resources (other parameters are not precluded) including its bandwidth and periodicity.

As discussed above, SL positioning are studied in the 3GPP Release-18 to expand and improve NR positioning. Prior to the study for SL positioning, a study on “Scenarios and requirements of in-coverage, partial coverage, and out-of-coverage NR positioning use cases” is conducted in Release-17, which is focused on V2X and public safety use cases. In addition, requirements for “Ranging based services” are developed, and positioning accuracy requirements are developed for IIoT use cases in out-of-coverage scenarios.

Table 7.3.2.2-1 in 3GPP TS 22.261 lists the performance requirements for different positioning service levels. It is noted that, along with horizontal and vertical accuracy requirements, the requirements on positioning service availability and positioning service latency are particularly very stringent for positioning service levels 4 (99.9% availability and 15 ms latency) and 6 (99.9% availability and 10 ms latency). The examples of scenarios/use cases of positioning service levels 4 and 6 include:

SL positioning is based on transmissions of SL PRSs by a plurality of anchor UEs, and the positioning accuracy may depend on synchronization between the anchor UEs. For SL synchronization, SL transmissions are organized in frames identified by a direct frame number (DFN). The DFN enables a UE to synchronize its radio frame transmissions according to the SL timing reference. UEs perform SL synchronization to have the same SL timing reference for SL communication among nearby UEs by synchronizing with a reference. There are five sources for synchronization reference (SyncRef): Global Navigation Satellite System (GNSS), NR Cell (or gNB), Evolved Universal Mobile Telecommunications System (UMTS) Terrestrial Radio Access Network (EUTRAN) Cell (or eNB), SyncRef UE or UE's own internal clock.

A UE selects its SyncRef (summarized in Table 1) in different priorities of the sources (where P0 to P6 correspond to highest to lowest priorities, respectively) depending on whether it is a GNSS-based synchronization (GNSS as the highest priority) or gNB/eNB-based synchronization (gNB/eNB has the highest priority).

TABLE 1
Priority groups of synchronization reference sources

| Priority | | |
|---|---|---|
| Group | GNSS-based synchronization | gNB/eNB-based synchronization |
| P0 | GNSS | gNB/eNB |
| P1 | UE directly synchronized to GNSS | UE directly synchronized to gNB/eNB (SyncRef |
| | (SyncRef UE in network coverage and | UE directly synchronized to gNB/eNB, i.e., with |
| | directly synchronized to GNSS, i.e., with | inCoverage = 1 and with SLSS ID = {1, . . . , 335}) |
| | inCoverage = 1 and SLSS ID = {0}) | |
| P2 | UE indirectly synchronized to GNSS | UE indirectly synchronized to gNB/eNB (SyncRef |
| | (SyncRef UE out of GNSS/network | UE out of GNSS/network coverage and one hop |
| | coverage and one hop away from GNSS, | away from a gNB/eNB, i.e., with inCoverage = 0 |
| | i.e., with inCoverage = 0 and SLSS ID = {0}) | and with SLSS ID = {1, . . . , 335}) |
| P3 | gNB/eNB | GNSS |
| P4 | UE directly synchronized to gNB/eNB | UE directly synchronized to GNSS (SyncRef UE |
| | (SyncRef UE directly synchronized to a | directly synchronized to GNSS, i.e., with |
| | gNB/eNB, i.e., with inCoverage = 1 and | inCoverage = 1 and SLSS ID = {0}) |
| | with SLSS ID = {1, . . . , 335}) | |
| P5 | UE indirectly synchronized to gNB/eNB | UE indirectly synchronized to GNSS (SyncRef UE |
| | (SyncRef UE out of GNSS/network | out of GNSS/network coverage and one hop away |
| | coverage and one hop away from a | from GNSS, i.e., with inCoverage = 0 and SLSS |
| | gNB/eNB, i.e., with inCoverage = 0 and | ID = {0}) |
| | with SLSS ID = {1, . . . , 335}) | |

| | |
|---|---|
| P6 | the remaining UEs have the lowest priority (including UE's own internal clock; SyncRef |
| | UE out of GNSS/network coverage and two or more hops away from a gNB/eNB |
| | or GNSS, i.e., with inCoverage = 0 and with SLSS ID = {336, 337, . . . , 671}) |

If there is no gNB/eNB or GNSS available as a SyncRef source, a UL performs a full search (i.e., covering all subframes and all possible Sidelink Synchronization Signal (SLSS) Identifications (IDs)) to detect a candidate SLSS to look for SyncRef UEs. It is noted, by detecting the SLSS sent by a SyncRef UL, a UL is able to synchronize to the SyncRef UL and estimate the beginning of the frame and carrier frequency. Upon successful SLSS detection, a UL proceeds with decoding a Physical Sidelink Broadcast Channel (PSBCH). If the UL has not selected a SyncRef UL as the source and multiple candidate SyncRef UEs (or SLSS IDs) are detected for which the PSBCH Reference Signal Receive Power (RSRP) exceeds the minimum requirement and the corresponding Master Information Block Sidelink (MIB-SL) is successfully received, the UE chooses the SyncRef UE with the highest PSBCH RSRP (PSBCH-RSRP) as the source considering the priority levels given in Table 1. After a UE selects a SyncRef UE as the source, it makes use of SL synchronization (sync) information carried in a Sidelink Synchronization Signal Block (S-SSB) transmitted by the SyncRef UE for synchronization.

In SL, UEs perform SL synchronization to have the same SL timing reference for SL communication among nearby UEs by synchronizing with a reference. In case gNB/eNB or GNSS are not available as a synchronization reference source, a UE may perform SL synchronization by synchronizing with a SyncRef UE as described above. However, there may still be synchronization misalignment between UEs due to sync misalignment of their respective SyncRefs.

In Time Difference of Arrival (TDOA) based SL positioning approaches, the positioning accuracy depends on the synchronization precession between the anchor UEs, where 1 nsec timing miss-alignment may lead to ˜36 cm positioning error. Hence, highly synchronized anchor UEs are required to support SL TDOA approaches for meeting the accuracy requirements of SL positioning. However, when SL synchronization procedure is adopted for SL positioning, the anchor UEs may not always be well synchronized. As a result, if there is synchronization misalignment among the anchor UEs in the SL positioning session, the positioning accuracy of the target UE is degraded. There is an open issue in SL positioning in 5G NR, in particular on how to minimize the impact of synchronization timing change in timing measurement based SL positioning such as SL TDOA-based, which is of interest in Release-18.

Example embodiments of the present disclosure propose a synchronization reference alignment scheme. To avoid synchronization misalignment among positioning anchor devices (such as anchor UEs) during SL positioning of a target device (such as a target UE), this scheme enables the positioning anchor device to synchronize with a common SyncRef source. With this scheme, a server device for the positioning, which may be a server UE, a Location Management Function (LMF), a gNB or eNB, or a GNSS, obtains information indicating a role (such as a role of a server device, a target device, or a positioning anchor device) of any device and/or quality of links between the device and the positioning anchor devices. Based on the obtained information, the server device determines a common SyncRef source for synchronization of at least one positioning anchor device. The target device means a UE from which an LMF or a server UE estimates the location, where the server UE may have a part or all of the functionality of the LMF. That is, the server UE may receive sidelink positioning measurements from a target device and one or multiple anchor devices, and it estimates the location of the target device based on the provided measurements.

In an example, the server device may trigger any device (which may be a target UE, a neighboring UE, an anchor UE, a server UE, a gNB/eNB or a GNSS) to act as the common SyncRef source, e.g., when no common SyncRef source can be identified using candidate SyncRef sources identified by the positioning anchor devices. Based on the common SyncRef source, synchronization misalignment among the positioning anchor devices may be avoided, thereby improving accuracy performance of SL positioning.

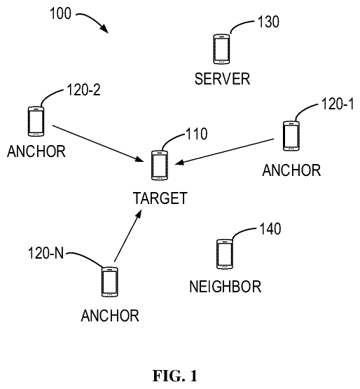

FIG. 1 illustrates an example communication environment 100 in which example embodiments of the present disclosure can be implemented.

The communication environment 100, which may be a part of a communication network, comprises a target device 110 to be positioned. The communication environment 100 further comprises a plurality of positioning anchor devices 120-1, 120-2, . . . , 120-N, which will also be referred to as an anchor. N represents any positive integer. For the purpose of discussion, the positioning anchor devices 120-1, 120-2, . . . , 120-N will be individually or collectively referred to as a positioning anchor device 120. The positioning anchor devices 120-1, 120-2, . . . , 120-N may support positioning of the target device 110, e.g., by transmitting and/or receiving reference signals for positioning, providing positioning-related information, and/or the like. For example, the positioning anchor devices 120 may provide PRS assistance (including PRSs) to the target device 110. In some example embodiments, in SL positioning, the target device 110 may be a target UE, and the positioning anchor device 120 may be an anchor UE.

In the communication environment 100, a server device 130 can provide a management function for the positioning of the target device 110. For example, the server device 130 may configure the positioning anchor devices 120-1, 120-2, . . . , 120-N for PRS transmission. Any device may act as the server device 130 such as a server UE, an LMF, a gNB, an eNB, a GNSS, a target UE, an anchor UE and any other devices. The communication environment 100 further comprises a device 140 and any other devices which can communicate with one or more of the target device 110, the positioning anchor devices 120, and the server device 130.

It is to be understood that the number and types of devices are shown in FIG. 1 for the purpose of illustration without suggesting any limitation. The communication environment 100 may comprise any numbers of service devices, positioning anchor target devices and target devices and may comprise any other devices. In some example embodiments, the communication environment 100 may comprise an LMF, a gNB, an eNB and/or a GNSS.

In the following, for the purpose of illustration, some example embodiments are described with these devices operating as terminal devices. However, in some example embodiments, operations described in connection with a terminal device may be implemented at a network device or other devices.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the communication environment 100, the SL positioning of the target device 110 is supported using SL via an SL interface such as a PC5 interface between the devices or a dedicated protocol for sidelink positioning (e.g., SLPP (Sidelink Positioning Protocol). The positioning anchor device 120 may support the SL positioning of the target device, e.g., by transmitting and/or receiving reference signals for positioning, providing positioning-related information and/or the like, e.g., over the SL interface. The target device 110 may use reference signals transmitted over SL, i.e., the PC5 interface, to obtain absolute position, relative position, or ranging information. Herein, the term “ranging” refers to determination of the distance and/or the direction between the target device 110 and another entity, e.g., the positioning anchor device 120.

In the communication environment 100, positioning may be based on the transmissions of PRSs by multiple positioning anchor devices 120-1, 120-2, . . . , 120-N to be received by the target device 110 in e.g., the SL TDOA approach or based on PRS exchange between the anchor(s) and the target device 110 in e.g., SL (multi-) Round Trip Time (RTT) approach to enable localization of the target device 110 and/or ranging of target device 110 with respect to the positioning anchor device 120 within certain latency and accuracy requirements of the positioning.

To improve accuracy performance of positioning in particular TDOA-based positioning, for a positioning session that positions the target device 110 using a set of positioning anchor devices 120-1, 120-2, . . . , 120-N, the server device 130 identifies a common SyncRef source for two or more of the positioning anchor devices 120-1, 120-2, . . . , 120-N and configures those positioning anchor devices 120-1, 120-2, . . . , 120-N to select the identified common SyncRef source to get SyncRef.

In some example embodiments, the selection of a common SyncRef source may be performed by the server device 130 based on information (referred to as first information) related to any devices (including the device 140). The first information indicates a role (such as a role of a server device, a target device, or a positioning anchor device) of any device and/or quality of links between the device and the positioning anchor devices. The server device 130 may trigger any device (e.g., the target device 110 or the device 140) to act as a common SyncRef source. In some embodiments, the server device 130 may transmit information (referred to as second information) related to the common SyncRef source to the positioning anchor devices.

In some example embodiments, the selection of a common SyncRef source may be based on information (referred to as third information) related to candidate SyncRef sources identified by the positioning anchor devices 120-1, 120-2, . . . , 120-N. In some example embodiments, the selection of a common SyncRef source may be performed in parallel based on the first information and the third information.

Alternatively, or in addition, the first and third information may be used in sequence. For example, if no common SyncRef source can be identified using the third information related to candidate SyncRef UEs identified by the positioning anchor devices 120-1, 120-2, . . . , 120-N, the first information related to other devices may be used. A device with a good (expected) radio link with the positioning anchor devices 120-1, 120-2, . . . , 120-N may be selected as the common SyncRef source.

In an example, in case of more than one potential common SyncRef source, the server device 130 may select the common SyncRef source which has the highest average PSBCH-RSRP to all positioning anchor devices 120-1, 120-2, . . . , 120-N. The average PSBCH RSRP may be a ratio of summation of PSBCH-RSRP with each positioning anchor device 120-1, 120-2, . . . , 120-N and the number of positioning anchor devices 120-1, 120-2, . . . , 120-N. Alternatively, or in addition, the server device 130 may select the common SyncRef source with highest sync priority or randomly chose a common SyncRef source.

In some example embodiments, at a side of the server device 130, the server device 130 may obtain the first information which indicates radio link conditions of any device to the positioning anchor devices 120-1, 120-2, . . . , 120-N. The radio link conditions may be indicated by Physical Sidelink Control Channel (PSCCH) RSRP with respect to the positioning anchor devices 120-1, 120-2, . . . , 120-N. The PSCCH RSRP may be based on sidelink control information (SCI), RSRP of an SL PRS, and/or RSRP of anchor discovery messages.

The first information further indicates roles of the devices involved in the positioning of the target device 110. The roles of devices in the positioning may impact the selection of the common SyncRef source. In an example, if a device has ‘target UE’ role in a sidelink positioning session, it may have a good link to all the anchor UEs (since the target UE has to receive SL PRS from the anchors). Hence, this device may be chosen as the common SyncRef source. In another example, if a device has ‘server UE’ role in a sidelink positioning session, it may have good links to all the anchor UEs (since the server UE may configure anchor UEs for SL PRS transmission). Hence, this device may be chosen as the common SyncRef source. In some example embodiments, the server device 130 may treat itself as a candidate SyncRef source and use its own radio link conditions and role for the selection of the common SyncRef source. The server device 130 may indicate the common SyncRef source to the positioning anchor devices 120-1, 120-2, . . . 120-N.

In some example embodiments, the server device 130 may receive the third information related to candidate SyncRef sources from the positioning anchor devices 120-1, 120-2, . . . , 120-N that may position at least the target device 110 in a positioning session. In some example embodiments, the server device 130 may select a common SyncRef source for the positioning anchor devices 120-1, 120-2, . . . , 120-N at least based on the first information from other devices indicating radio link conditions to the positioning anchor devices 120-1, 120-2, . . . , 120-N, and roles of the devices involved in the positioning of the target device 110 and/or the third information related to candidate SyncRef sources from positioning anchor devices 120-1, 120-2, . . . , 120-N.

In some example embodiments, at a side of the positioning anchor device 120, the positioning anchor device 120-1, 120-2, . . . , 120-N may send the third information related to candidate SyncRef sources to the server device 130. The positioning anchor device 120-1, 120-2, . . . , 120-N may receive the second information related to the common SyncRef source from server device 130. In some example embodiments, if any other device such as the target device 110 is selected as the common SyncRef source based on the first information, the positioning anchor device 120-1, 120-2, . . . , 120-N may receive the second information from the selected device. The positioning anchor device 120-1, 120-2, . . . , 120-N may synchronize with the common SyncRef source indicated in the second information.

In some example embodiments, at a side of the device 140 or any other devices, the device 140 may indicate to the server device 130 its role in the positioning session (if participating). The device 140 may send to the server device 130 radio link quality information (e.g., PSCCH RSRP) with respect to the positioning anchor devices 120-1, 120-2, . . . , 120-N. In some example embodiments, the device 140 may send the first information to the server device 130 based on a request from the server device 130 to report on radio link quality with respect to two or more positioning anchor devices 120-1, 120-2, . . . , 120-N.

In some example embodiments, if the device 140 is selected as a common SyncRef source, the device 140 may receive a trigger to act as a common SyncRef source. The device 140 may transmit a synchronization reference signal to the at least one positioning anchor devices 120-1, 120-2, . . . , 120-N. In some example embodiments, the device 140 may provide its identification (ID) such as SyncRef ID (e.g., SLSS ID) to the server device 130 and/or one or more positioning anchor devices 120-1, 120-2, . . . , 120-N. In the case that the ID of the device 140 is transmitted to the server device 130, the server device 130 may transmit this ID to the positioning anchor devices 120-1, 120-2, . . . , 120-N. In some example embodiments, the ID may be transmitted to the server device 130 as part of the first information.

In this way, all positioning anchor devices 120-1, 120-2, . . . , 120-N is made to synchronize with a common SyncRef source. As such, synchronization misalignment among the positioning anchor devices 120-1, 120-2, . . . , 120-N may be avoided, and the positioning accuracy may be improved.

The selection of the common SyncRef source is required to enable each positioning anchor device 120-1, 120-2, . . . , 120-N to be able to successfully receive a SyncRef signal from the source. In some example embodiments, a device which already has (or expected to have) a good radio link to the positioning anchor devices 120-1, 120-2, . . . , 120-N may be elevated as a common SyncRef source to the positioning anchor devices 120-1, 120-2, . . . , 120-N so that all the positioning anchor devices 120-1, 120-2, . . . , 120-N have the same SyncRef. The prediction may be done based on the role of the device. For example, the target device 110 can be expected to have a good radio link quality to the positioning anchor device 120-1, 120-2, . . . , 120-N. This is because during the anchor selection phase, only those anchors which have good radio links (for successful SL PRS reception at the target device 110) to the target device 110 may have been chosen as anchors for positioning of the target device 110.

In some example embodiments, candidate SyncRef sources identified by the positioning anchor devices 120-1, 120-2, . . . , 120-N during SyncRef search may be exploited to find the common SyncRef source that is acceptable at all the positioning anchor devices 120-1, 120-2, . . . , 120-N.

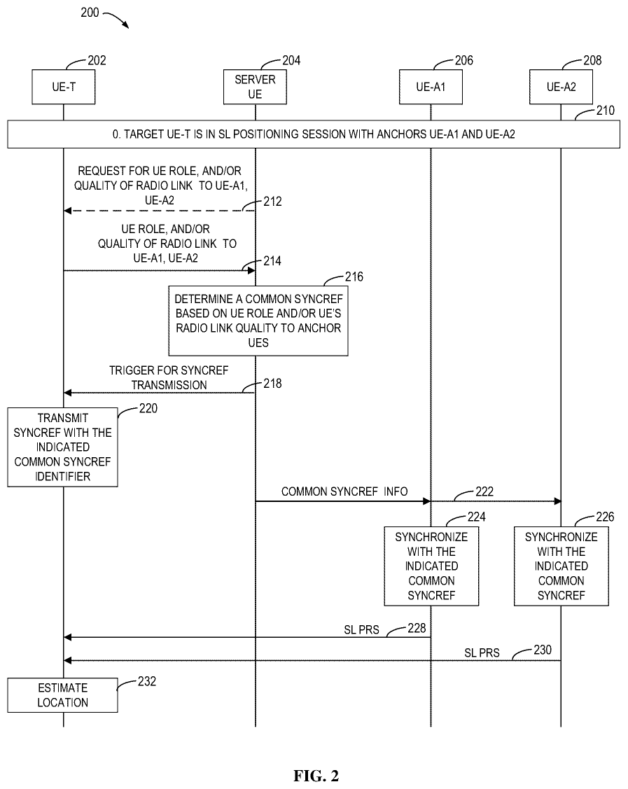

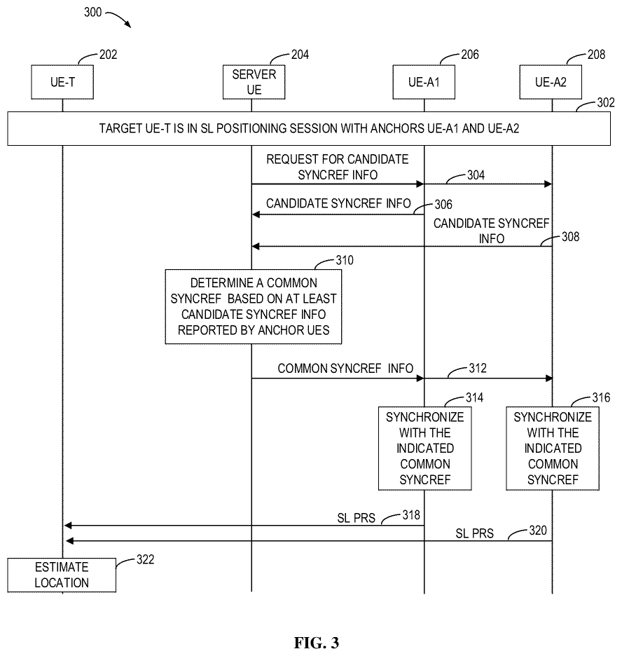

Some example implementations of selecting the common SyncRef source based on the first information from any other devices and based on the second information related to candidate SyncRef sources identified by the positioning anchor devices will be described below with reference to FIGS. 2 and 3, respectively.

### Example Embodiment A

FIG. 2 illustrates an example process 200 of synchronization reference alignment based on the first information according to some example embodiments of the present disclosure. In this example, a target UE 202, denoted by UE-T, may operate as the target device 110. A server UE 204 may operate as the server device 130. Two anchor UEs 206 and 208, denoted by UE-A1 and UE-A2, respectively, may operate as the positioning anchor devices 120.

At 210, the target UE 202 is in DL-TDOA-like SL-TDOA-based SL positioning session with the anchor UEs 206 and 208. In this example, a UE (such as Target UE 202) which may not be currently acting as SyncRef source is chosen as a common SyncRef source for the anchor UEs 206 and 208. For determination of which UE can be made to trigger SyncRef, the target UE 202 may report (214) its radio link quality to all the anchor UEs 206 and 208 (e.g., RSRP associated with an SL discovery message or an SL PRS). Additionally, the server UE 204 may request (212) and get UE role information (e.g., a target UE, a server UE, not-in-positioning-session) from the target UE 202 and UEs. Also, the target UE 202 may recommend its SLSS ID in case the target UE 202 is chosen as a common SyncRef source.

The common SyncRef UE is then determined (216) based on the UE role and/or the radio link quality. For example, the target UE 202 which is acting as a target may be chosen as the common SyncRef source since the target UE 202 is expected to have a higher link quality with the anchor UEs 206 and 208 (the anchor selection procedure may have ensured this). Then, the target UE 202 may be assigned with the SLSS ID which may be determined based on the SLSS ID recommendation from the target UE 202.

At 218, the chosen UE (i.e., the target UE 202) is triggered to transmit SyncRef. Upon receiving the trigger, at 220, the chosen UE (i.e., the target UE 202) starts transmitting S-SSB with the indicated SLSS ID. At 222, the server UE 204 indicates the common SyncRef to the anchor UEs 206 and 208. The common SyncRef is identified by SLSS ID. In an embodiment, instead of the server UE 204, the chosen UE (i.e., the target UE 202) may be configured to send the third information relate to the common SyncRef source over sidelink to the anchor UEs 206 and 208.

At 224 and 226, the anchor UEs 206 and 208 monitor for the indicated common SyncRef and synchronize with it. At 228 and 230, the anchor UEs 206 and 208 transmit SL PRSs. Then, the target UE 202 receives SL PRSs and performs SL positioning measurement (e.g., SL Reference Signal Time Difference (RSTD)). At 232, the target UE 202 estimates its location.

### Example Embodiment B

FIG. 3 illustrates an example process 300 of synchronization reference alignment based on the third information related to candidate SyncRef sources reported by the anchor UEs 206 and 208 according to some example embodiments of the present disclosure.

At 302, the target UE 202 is in DL-TDOA-like SL-TDOA-based SL positioning session with the anchor UEs 206 and 208. At 304, the server UE 204 (or an LMF) requests the anchor UEs 206 and 208 to perform synchronization search and report the information on the synchronization candidates. That is, the reporting may be based on the request for the third information related to candidate SyncRef sources from the server UE (or LMF). At 306 and 308, the anchor UEs 206 and 208 report candidate SyncRef UEs to the server UE 204 (or the LMF).

For example, in out of coverage conditions (i.e., when there is no gNB/eNB or GNSS available as SyncRef source), the anchor UEs 206 and 208 performs a full search (i.e., covering all subframes and all possible SLSS IDs) to detect candidate SLSS to look for SyncRef UEs. Upon successful SLSS detection, the anchor UEs 206 and 208 proceed with decoding the PSBCH. Here, the anchor UEs 206 and 208 may detect multiple candidate SyncRef UEs (or SLSS IDs) for which the PSBCH-RSRP exceeds the minimum requirement by sl-SyncRefMinHyst and the corresponding MIB-SL is successfully received. The anchor UEs 206 and 208 then reports all the candidate SyncRef UEs to the server UE 204. It is to be understood that the proposed scheme may be also applicable in in-coverage scenarios. The candidate SyncRef UE info contains a list of candidate SyncRef UEs (e.g., SLSS IDs and/or UE IDs), RSRP for each candidate SyncRef UEs, and Priority group of each SyncRef UEs.

At 310, the server UE 204 selects a common SyncRef for the anchor UEs 206 and 208 at least based on the third information related to candidate SyncRef sources received from the anchor UEs 206 and 208 at 306 and 308. The common SyncRef selection may also be based on the first information indicating a UE's radio link conditions to the anchor UEs 206 and 208 and/or the UE roles of UEs involved in the sidelink positioning session (e.g., the target UE 202). This is captured in Embodiment A.

In case of more than one potential common SyncRef UE, the server UE 204 may select the SyncRef which has the highest average PSBCH-RSRP to all the anchor UEs 206 and 208 where average PSBCH RSRP is equal to a ratio of the summation of PSBCH-RSRP with each anchor UE and the number of anchor UEs. Alternatively, the server UE 204 may select the SyncRef with highest sync priority. In an embodiment, the server UE 204 selects a SyncRef from a SyncRef UE as the common SyncRef if the SyncRef UE is listed as a candidate SyncRef UE by all the anchor UEs 206 and 208.

At 312, the server UE indicates the common SyncRef to the anchor UEs 206 and 208. In an embodiment, the common SyncRef is identified by SLSS ID. At 314 and 316, the anchor UEs 206 and 208 monitor for the indicated common SyncRef and synchronize with it. At 318 and 320, the anchor UEs 206 and 208 transmit SL PRS. Then, the target UE 202 receives SL PRS and performs SL positioning measurement (e.g., SL RSTD). At 322, the target UE 202 estimates its location.

Because the anchor UEs 206 and 208 use the same common SyncRef source, the anchor UEs 206 and 208 are well synchronized and hence there is no time misalignment between the anchors. This allows accurate SL RSTD measurement at the target UE 202.

### Example Methods

FIG. 4 shows a flowchart of an example method 400 implemented at a server device in accordance with some example embodiments of the present disclosure. For the purpose of discussion, the method 400 will be described from the perspective of the server device 130 in FIG. 1.

At block 410, the server device 130 obtains first information indicating at least one of: a role of a device of at least one device during positioning of a target device based on at least sidelink positioning reference signals, or quality of a plurality of links between the device of the at least one device and a plurality of positioning anchor devices for the positioning of the target device. At block 420, the server device 130 determines, based on at least the first information, a common synchronization reference source for synchronization of at least one of the plurality of positioning anchor devices.

In some example embodiments, the server device 130 may receive the first information from the at least one device.

In some example embodiments, the server device 130 may in response to selecting the device of the at least one device as the common synchronization reference source, transmit, to the selected device, a trigger for transmitting a synchronization reference signal.

In some example embodiments, the server device 130 may transmit, to at least one of the plurality of positioning anchor devices, second information related to the common synchronization reference source.

In some example embodiments, the server device 130 may receive an identification of the selected device from the selected device, wherein the second information includes the identification of the selected device to the plurality of positioning anchor devices.

In some example embodiments, the first information from the selected device may contain the identification of the selected device.

In some example embodiments, the server device 130 may transmit, to the at least one device, a request to provide the first information.

In some example embodiments, the server device 130 may receive, from the plurality of positioning anchor devices, third information related to at least one candidate synchronization reference source, wherein the common synchronization reference source is determined from the at least one device and the at least one candidate synchronization reference source based on the first and third information.

In some example embodiments, the third information may include at least one of: a further identification of a candidate synchronization reference source of the at least one candidate synchronization reference source, a signal strength associated with a candidate synchronization reference source of the at least one candidate synchronization reference source, a priority of a candidate synchronization reference source of the at least one candidate synchronization reference source.

In some example embodiments, the server device 130 may in response to selecting a candidate synchronization reference source of the at least one candidate synchronization reference source as the common synchronization reference source, transmit, to at least one of the plurality of positioning anchor devices, second information related to the common synchronization reference source.

In some example embodiments, the server device 130 may transmit, to the plurality of positioning anchor devices, a request to provide the third information.

In some example embodiments, the role of the device may comprise at least one of a role of a positioning anchor device, the target device or a server device during the positioning of the target device.

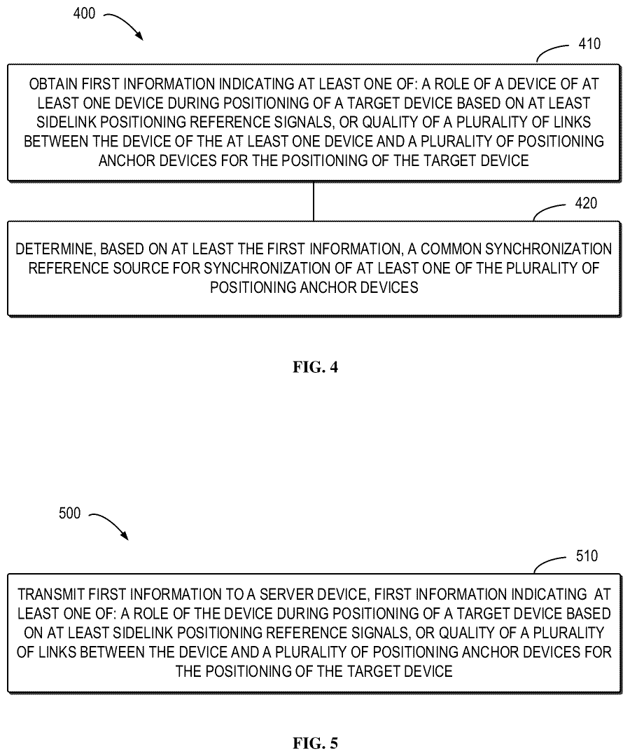

FIG. 5 shows a flowchart of an example method 500 implemented at a device in accordance with some example embodiments of the present disclosure. For the purpose of discussion, the method 500 will be described from the perspective of the device 140 in FIG. 1.

At block 510, the device 140 transmits first information to a server device, first information indicating at least one of: a role of the device during positioning of a target device based on at least sidelink positioning reference signals, or quality of a plurality of links between the device and a plurality of positioning anchor devices for the positioning of the target device.

In some example embodiments, the device 140 may receive, from the server device, a trigger for transmitting a synchronization reference signal; and transmitting the synchronization reference signal.

In some example embodiments, the device 140 may transmit an identification of the device to at least one of: the server device, or at least one of the plurality of positioning anchor devices.

In some example embodiments, the device 140 may receive, from the server device, a request to provide the first information.

In some example embodiments, the role of the device may comprise a role of a positioning anchor device, the target device or a server device during the positioning of the target device.

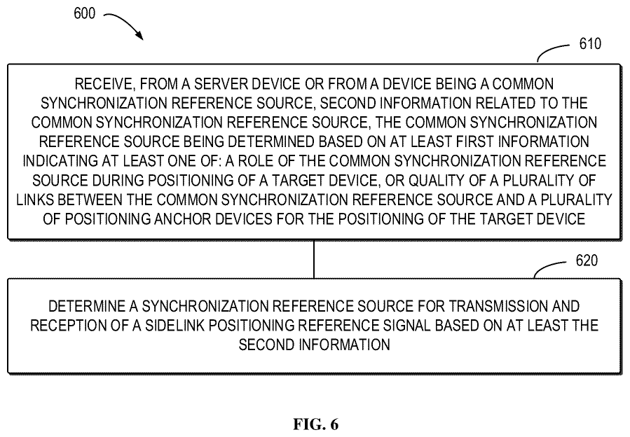

FIG. 6 shows a flowchart of an example method 600 implemented at a positioning anchor device in accordance with some example embodiments of the present disclosure. For the purpose of discussion, the method 600 will be described from the perspective of the positioning anchor device 120 in FIG. 1.

At block 610, the positioning anchor device 120 receives, from a server device or from a device being a common synchronization reference source, second information related to the common synchronization reference source, the common synchronization reference source being determined based on at least first information indicating at least one of: a role of the common synchronization reference source during positioning of a target device, or quality of a plurality of links between the common synchronization reference source and a plurality of positioning anchor devices for the positioning of the target device. At block 630, the positioning anchor device 120 determines a synchronization reference source for transmission and reception of a sidelink positioning reference signal based on at least the second information.

In some example embodiments, the positioning anchor device 120 may transmit, to the server device, third information related to at least one candidate synchronization reference source, wherein the common synchronization reference source is determined based on the first and third information.

In some example embodiments, the third information may include at least one of: an identification of a candidate synchronization reference source of the at least one candidate synchronization reference source, a signal strength associated with a candidate synchronization reference source of the at least one candidate synchronization reference source, a priority of a candidate synchronization reference source of the at least one candidate synchronization reference source.

In some example embodiments, the positioning anchor device 120 receive, from the server device, a request to provide the third information.

In some example embodiments, the role of the common synchronization reference source may comprise at least one of a role of a positioning anchor device, the target device or a server device during the positioning of the target device.

### Example Apparatus, Device and Medium

In some example embodiments, a first apparatus capable of performing the method 400 (for example, the server device 130 in FIG. 1) may comprise means for performing the respective operations of the method 400. The means may be implemented in any suitable form. For example, the means may be implemented in a circuitry or software module. The first apparatus may be implemented as or included in the server device 130 in FIG. 1.

In some example embodiments, the first apparatus comprises means for obtaining first information indicating at least one of: a role of a device of at least one device during positioning of a target device based on at least sidelink positioning reference signals, or quality of a plurality of links between the device of the at least one device and a plurality of positioning anchor devices for the positioning of the target device; and means for determining, based on at least the first information, a common synchronization reference source for synchronization of at least one of the plurality of positioning anchor devices.

In some example embodiments, the first apparatus further comprises: means for receiving the first information from the at least one device.

In some example embodiments, the first apparatus further comprises: means for in response to selecting the device of the at least one device as the common synchronization reference source, transmitting, to the selected device, a trigger for transmitting a synchronization reference signal.

In some example embodiments, the first apparatus further comprises: means for transmitting, to the plurality of positioning anchor devices, second information related to the common synchronization reference source.

In some example embodiments, the first apparatus further comprises: means for receiving an identification of the selected device from the selected device, wherein the second information includes the identification of the selected device to the plurality of positioning anchor devices.

In some example embodiments, the first information from the selected device contains the identification of the selected device.

In some example embodiments, the first apparatus further comprises: means for transmitting, to the at least one device, a request to provide the first information.

In some example embodiments, the first apparatus further comprises: means for receiving, from the plurality of positioning anchor devices, third information related to at least one candidate synchronization reference source, wherein the common synchronization reference source is determined from the at least one device and the at least one candidate synchronization reference source based on the first and third information.

In some example embodiments, the third information includes at least one of: a further identification of a candidate synchronization reference source of the at least one candidate synchronization reference source, a signal strength associated with a candidate synchronization reference source of the at least one candidate synchronization reference source, a priority of a candidate synchronization reference source of the at least one candidate synchronization reference source.

In some example embodiments, the first apparatus further comprises: means for in response to selecting a candidate synchronization reference source of the at least one candidate synchronization reference source as the common synchronization reference source, transmitting, to the plurality of positioning anchor devices, second information related to the common synchronization reference source.

In some example embodiments, the first apparatus further comprises: means for transmitting, to the plurality of positioning anchor devices, a request to provide the third information.

In some example embodiments, the role of the device comprises at least one of a role of a positioning anchor device, the target device or a server device during the positioning of the target device.

In some example embodiments, the first apparatus further comprises means for performing other operations in some example embodiments of the method 400 or the server device 130. In some example embodiments, the means comprises at least one processor; and at least one memory storing instructions that, when executed by the at least one processor, cause the performance of the first apparatus.

In some example embodiments, a second apparatus capable of performing the method 500 (for example, the device 140 in FIG. 1) may comprise means for performing the respective operations of the method 500. The means may be implemented in any suitable form. For example, the means may be implemented in a circuitry or software module. The second apparatus may be implemented as or included in the device 140 in FIG. 1.

In some example embodiments, the second apparatus comprises means for transmitting first information to a server device, first information indicating at least one of: a role of the device during positioning of a target device based on at least sidelink positioning reference signals, or quality of a plurality of links between the device and a plurality of positioning anchor devices for the positioning of the target device.

In some example embodiments, the second apparatus further comprises: means for receiving, from the server device, a trigger for transmitting a synchronization reference signal; and means for transmitting the synchronization reference signal.

In some example embodiments, the second apparatus further comprises: means for transmitting an identification of the device to at least one of: the server device, or at least one of the plurality of positioning anchor devices.

In some example embodiments, the second apparatus further comprises: means for receiving, from the server device, a request to provide the first information.

In some example embodiments, the role of the device comprises a role of a positioning anchor device, the target device or a server device during the positioning of the target device.

In some example embodiments, the second apparatus further comprises means for performing other operations in some example embodiments of the method 500 or the device 140. In some example embodiments, the means comprises at least one processor; and at least one memory storing instructions that, when executed by the at least one processor, cause the performance of the second apparatus.

In some example embodiments, a third apparatus capable of performing any of the method 600 (for example, the positioning anchor device 120 in FIG. 1) may comprise means for performing the respective operations of the method 600. The means may be implemented in any suitable form. For example, the means may be implemented in a circuitry or software module. The third apparatus may be implemented as or included in the positioning anchor device 120 in FIG. 1.

In some example embodiments, the third apparatus comprises means for receiving, from a server device or from a device being a common synchronization reference source, second information related to the common synchronization reference source, the common synchronization reference source being determined based on at least first information indicating at least one of: a role of the common synchronization reference source during positioning of a target device, or quality of a plurality of links between the common synchronization reference source and a plurality of positioning anchor devices for the positioning of the target device; and means for determining a synchronization reference source for transmission and reception of a sidelink positioning reference signal based on at least the second information.

In some example embodiments, the third apparatus further comprises: means for transmitting, to the server device, third information related to at least one candidate synchronization reference source, wherein the common synchronization reference source is determined based on the first and third information.

In some example embodiments, the third information includes at least one of: an identification of a candidate synchronization reference source of the at least one candidate synchronization reference source, a signal strength associated with a candidate synchronization reference source of the at least one candidate synchronization reference source, a priority of a candidate synchronization reference source of the at least one candidate synchronization reference source.

In some example embodiments, the third apparatus further comprises: means for receiving, from the server device, a request to provide the third information.

In some example embodiments, the role of the common synchronization reference source comprises at least one of a role of a positioning anchor device, the target device or a server device during the positioning of the target device.

In some example embodiments, the third apparatus further comprises means for performing other operations in some example embodiments of the method 600 or the positioning anchor device 120. In some example embodiments, the means comprises at least one processor; and at least one memory storing instructions that, when executed by the at least one processor, cause the performance of the third apparatus.

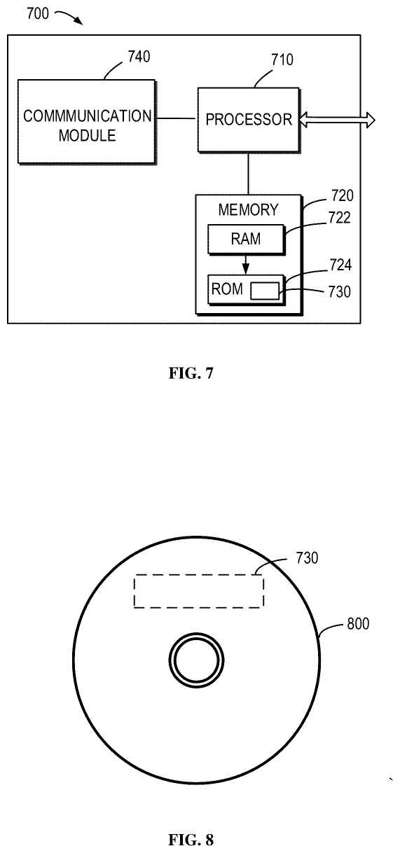

FIG. 7 is a simplified block diagram of a device 700 that is suitable for implementing example embodiments of the present disclosure. The device 700 may be provided to implement a communication device, for example, the server device 130, or the device 140 or the positioning anchor device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 1 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A computing device comprising:
at least one processor; and
at least one memory storing instructions that, when executed by the at least one processor, cause the computing device at least to:
during out of coverage conditions when no server node and no Global Navigation Satellite System (GNSS) available for synchronization reference source requests, request a plurality of anchor devices to perform a synchronization search for synchronization candidates for sidelink positioning of a target device;
receive, from the plurality of anchor devices, first information related to at least one candidate synchronization reference source, wherein the first information comprises: an identification of a candidate synchronization reference source, a signal strength associated with the candidate synchronization reference source, a priority of the candidate synchronization reference source,
obtain second information indicating the following: a role of the candidate synchronization reference source during positioning of a target device based on sidelink positioning reference signals, a quality of a plurality of links between the candidate synchronization reference source and the plurality of anchor devices for the positioning of the target device;
select, based on the first information and the second information, the candidate synchronization reference source as a common synchronization reference source for synchronization of the plurality of anchor devices;
in response to selecting the candidate synchronization reference source as the common synchronization reference source, transmit, to the common synchronization reference source and the plurality of anchor devices, a trigger for transmitting a synchronization reference signal;
upon transmitting the synchronization reference signal, receive sidelink positioning measurements from the target device and the plurality of anchor devices; and
based on the sidelink positioning measurements, estimate a location of the target device.

22. The computing device of claim 21, wherein the at least one memory and the at least one processor further cause the computing device to:
receive the second information from the candidate synchronization reference source.

23. The computing device of claim 22, wherein the at least one memory and the at least one processor further cause the computing device to:
transmit, to the plurality anchor devices, second information related to the common synchronization reference source.

24. The computing device of claim 23, wherein the at least one memory and the at least one processor further cause the computing device to:
receive an identification of the common synchronization reference source from the common synchronization reference source.

25. The computing device of claim 24, wherein the second information from the candidate synchronization reference source contains the identification of the candidate synchronization reference source.

26. The computing device of claim 25, wherein the at least one memory and the at least one processor further cause the computing device to:
transmit, to the candidate synchronization reference source, a request to provide the second information.

27. The computer device of claim 26, wherein the common synchronization reference source is the target device.

28. A system comprising:
a computing device:
at least one processor; and
at least one memory storing instructions that, when executed by the at least one processor, cause the computing device at least to:
during out of coverage conditions when no server node and no Global Navigation Satellite System (GNSS) available for synchronization reference source requests, request a plurality of anchor devices to perform a synchronization search for synchronization candidates for sidelink positioning of a target device;
receive, from the plurality of anchor devices, first information related to at least one candidate synchronization reference source, wherein the first information comprises: an identification of a candidate synchronization reference source, a signal strength associated with the candidate synchronization reference source, a priority of the candidate synchronization reference source,
obtain second information indicating the following: a role of the candidate synchronization reference source during positioning of a target device based on sidelink positioning reference signals, a quality of a plurality of links between the candidate synchronization reference source and the plurality of anchor devices for the positioning of the target device;
select, based on the first information and the second information, the candidate synchronization reference source as a common synchronization reference source for synchronization of the plurality of anchor devices;
in response to selecting the candidate synchronization reference source as the common synchronization reference source, transmit, to the common synchronization reference source and the plurality of anchor devices, a trigger for transmitting a synchronization reference signal;
upon transmitting the synchronization reference signal, receive sidelink positioning measurements from the target device and the plurality of anchor devices; and
based on the sidelink positioning measurements, estimate a location of the target device.

29. The system of claim 28, wherein the at least one memory and the at least one processor further cause the computing device to:
receive the second information from the candidate synchronization reference source.

30. The system of claim 29, wherein the at least one memory and the at least one processor further cause the computing device to:
transmit, to the plurality anchor devices, second information related to the common synchronization reference source.

31. The system of claim 30, wherein the at least one memory and the at least one processor further cause the computing device to:
receive an identification of the common synchronization reference source from the common synchronization reference source.

32. The system of claim 31, wherein the second information from the candidate synchronization reference source contains the identification of the candidate synchronization reference source.

33. The system of claim 32, wherein the at least one memory and the at least one processor further cause the computing device to:
transmit, to the candidate synchronization reference source, a request to provide the second information.

34. The system of claim 33, wherein the common synchronization reference source is the target device.

35. A method comprising:
during out of coverage conditions when no server node and no Global Navigation Satellite System (GNSS) available for synchronization reference source requests:
request, by a computing device, a plurality of anchor devices to perform a synchronization search for synchronization candidates for sidelink positioning of a target device;
receive, from the plurality of anchor devices, first information related to at least one candidate synchronization reference source, wherein the first information comprises: an identification of a candidate synchronization reference source, a signal strength associated with the candidate synchronization reference source, a priority of the candidate synchronization reference source,
obtain second information indicating the following: a role of the candidate synchronization reference source during positioning of a target device based on sidelink positioning reference signals, a quality of a plurality of links between the candidate synchronization reference source and the plurality of anchor devices for the positioning of the target device;
select, based on the first information and the second information, the candidate synchronization reference source as a common synchronization reference source for synchronization of the plurality of anchor devices;
in response to selecting the candidate synchronization reference source as the common synchronization reference source, transmit, to the common synchronization reference source and the plurality of anchor devices, a trigger for transmitting a synchronization reference signal;
upon transmitting the synchronization reference signal, receive sidelink positioning measurements from the target device and the plurality of anchor devices; and
based on the sidelink positioning measurements, estimate a location of the target device.

36. The method of claim 35, further comprising: receiving the second information from the candidate synchronization reference source.

37. The method of claim 36, further comprising: transmitting, to the plurality anchor devices, second information related to the common synchronization reference source.

38. The method of claim 37, further comprising: receiving an identification of the common synchronization reference source from the common synchronization reference source.

39. The method of claim 38, wherein the second information from the candidate synchronization reference source contains the identification of the candidate synchronization reference source.

40. The method of claim 39, wherein the common synchronization reference source is the target device.
